(19) United States
(12) Patent Application Publication
(10) Pub. No.: US 2023/0189842 A1
(43) Pub. Date: Jun. 22, 2023

(54) PRODUCTS DERIVED FROM GREEN BANANAS OR PLANTAINS

(71) Applicant: BANANA FEEDS AUSTRALIA PTY LTD, Woree, Queensland (AU)

(72) Inventors: Robert Borsato, Cairns (AU); John Douglas McArthur, Stirling (AU)

(73) Assignee: BANANA FEEDS AUSTRALIA PTY LTD, Woree, Queensland (AU)

(21) Appl. No.: 17/759,858

(22) PCT Filed: Jan. 29, 2021
(86) PCT No.: PCT/AU2021/000009

§ 371 Date: Jul. 31, 2022

(30) Foreign Application Priority Data
Jan. 31, 2020 (AU) 2020900275
Jul. 9, 2020 (AU) 2020902369

(51) Int. Cl. A23K 10/37; A23B 7/02; A23K 30/20; A23K 40/10; A23L 19/00

(52) U.S. Cl. CPC A23K 10/37; A23B 7/02; A23K 30/20; A23K 40/10; A23L 19/01

(57) ABSTRACT

A product includes dehydrated flesh of green bananas and/or plantains and/or dehydrated non-flesh banana plant material. The product may be used as an animal or human feed product, a nutraceutical product or a component of a nutraceutical product. The processes for producing the product are also disclosed.

### PRIORITY DOCUMENTS

The present application claims priority from Australian Provisional Patent Application No. 2020900275 titled “PRODUCTS DERIVED FROM GREEN BANANAS OR PLANTAINS” filed on 31 Jan. 2020 and Australian Provisional Patent Application No. 2020902369 titled “IMPROVED PRODUCTS DERIVED FROM GREEN BANANAS OR PLANTAINS” filed on 9 Jul. 2020. The content of each application is hereby incorporated by reference in its entirety.

### TECHNICAL FIELD

The present disclosure relates generally to compositions that are suitable for use as feed products, supplements, additives or nutraceuticals, and more specifically to compositions formed from green bananas and/or plantains that are suitable for use as animal and human feed products, supplements, additives or nutraceuticals.

### BACKGROUND

Feed supplements or additives (generally referred to herein as “feed products”) are commonly used in the course of animal husbandry in order to provide additional nutrition or therapeutic benefit that is not otherwise provided via forage or other feeds. In addition, specific animals in specific settings, such as horses subjected to stress due to intensive athletic work or reproduction, may need tailored nutrition which can be provided by feed products. For example, extra fat, protein, vitamins and minerals can be added to an animal’s diet in this way. The nutritional quality of feed is influenced not only by the nutrient content, but also by many other factors such as feed presentation, hygiene, digestibility, and effect on intestinal health.

There is a large range of commercially prepared feed products on the market. Many feed manufacturers combine various grains and add additional vitamin and mineral supplements to create a feed that is easy for owners to feed and of predictable nutritional quality. Many of these manufactured feed products are formed from complex mixtures of starting ingredients, are relatively expensive, and/or do not necessarily provide a range of nutritional benefits.

There is thus a need to provide a manufactured feed product that provides a range of nutritional benefits to an animal or human and/or can be produced economically and/or provides a useful alternative to known manufactured feed products.

### SUMMARY

According to a first aspect of the present disclosure, there is provided a product comprising dehydrated flesh of green bananas and/or plantains and/or dehydrated non-flesh banana plant material.

In certain embodiments, the non-flesh banana plant material is selected from skin, stems, flowers, and parts of the aforementioned.

In certain embodiments, the product is in the form of a crumble.

In certain other embodiments, the product is in the form of a powder.

In certain embodiments, the product is an animal or human feed product.

In certain other embodiments, the product is a nutraceutical product.

In certain embodiments, the product has a resistant starch content of at least about 39% (by weight).

According to a second aspect of the present disclosure, there is provided a product comprising dehydrated flesh of green bananas and/or plantains.

In certain embodiments, the product is in the form of a crumble.

In certain other embodiments, the product is in the form of a powder.

In certain embodiments, the product is an animal or human feed product.

In certain other embodiments, the product is a nutraceutical product.

In certain embodiments, the product has a resistant starch content of at least about 39% (by weight).

According to a third aspect of the present disclosure, there is provided a process for producing a product comprising dehydrated flesh and skin of green bananas or plantains, the process comprising:
slicing whole green bananas or plantains to form banana or plantain slices comprising flesh and skin;
dehydrating said banana or plantain slices to form dehydrated green banana or plantain slices to form the product in the form of slices; or
dehydrating said banana or plantain slices to form dehydrated green banana slices and comminuting said dehydrated banana or plantain slices to form the product comprising dehydrated flesh and skin of green bananas or plantains.

According to a fourth aspect of the present disclosure, there is provided a product comprising dehydrated non-flesh banana plant material.

In certain embodiments, the non-flesh banana plant material is selected from skin, stems, flowers, and parts of the aforementioned.

In certain embodiments, the product is in the form of a crumble.

In certain other embodiments, the product is in the form of a powder.

In certain embodiments, the product is an animal or human feed product.

In certain other embodiments, the product is a nutraceutical product.

According to a fifth aspect of the present disclosure, there is provided a process for producing a product comprising dehydrated non-flesh banana plant material, the process comprising:
obtaining whole or part non-flesh plant material from green bananas or plantains;
dehydrating said whole or part non-flesh plant material to form dehydrated non-flesh banana plant material; and
optionally comminuting said dehydrated non-flesh banana plant material to form the product comprising dehydrated non-flesh banana plant material.

In certain embodiments, the process of the fifth aspect further comprises mixing said dehydrated non-flesh banana plant material and/or comminuted dehydrated non-flesh banana plant material with dehydrated flesh of green bananas or plantains to form a product comprising dehydrated flesh of green bananas or plantains and dehydrated non-flesh banana plant material.

In certain embodiments, the non-flesh banana plant material is selected from skin, stems, flowers, and parts of the aforementioned.

### BRIEF DESCRIPTION OF THE FIGURES

Embodiments of the present disclosure will be discussed with reference to the accompanying figures wherein:

FIG. 1 is a flow diagram showing steps in a production process for producing a feed product or a nutraceutical as described herein;

FIG. 2 shows photographs of a product comprising dehydrated flesh and skin of green bananas in the form of a crumble that was prepared according to embodiments described herein;

FIG. 3 shows photographs of a product comprising dehydrated flesh and skin of green bananas in the form of a powder that was prepared according to embodiments described herein; and

FIG. 4 shows photographs of a growing banana bell (right) and also dried and crushed banana bell (left and middle); and

FIG. 5 shows plots of total flavanoid content (left), total antioxidant content (middle), and total polyphenol content (right).

### DESCRIPTION OF EMBODIMENTS

Disclosed herein is a product comprising dehydrated flesh of green bananas or plantains or dehydrated non-flesh banana plant material. Also disclosed herein is a product comprising dehydrated non-flesh banana plant material. Following is a description of certain exemplary embodiments of the products and processes for making the products disclosed herein. These embodiments are described for illustration purposes and the present disclosure is not limited to the exemplary embodiments, but is capable of numerous rearrangements, modifications and substitutions without departing from the scope of the invention.

As used herein, the term “green banana” means a banana having a color rating of 3 or less on the following color scale of 1 through 7: a banana having a peel that is all green has a color rating of 1, a banana having a peel that is green with a trace of yellow has a color rating of 2, a banana having a peel that is more green than yellow has a color rating of 3, a banana having a peel that is more yellow than green has a color rating of 4, a banana having a peel that is yellow with a trace of green has a color rating of 5, a banana having a peel that is all yellow has a color rating of 6, and a banana having a peel that is all yellow with brown speckles has a color rating of 7. In contrast to green bananas, a yellow banana has a color rating of 4 or more on the color scale of 1 through 7.

The term “green banana” encompasses any edible fruits of the genus Musa that meets the above criteria for categorisation as green.

As used herein, the term “plantain” means green plantain or yellow plantain. The color scale referred to above for green bananas also applies to plantains. In other words, a “green plantain” is a plantain having a color rating of 3 or less on the color scale of 1 through 7 and a “yellow plantain” is a plantain having a color rating of 4 or more on the color scale of 1 through 7.

Bananas and plantains are edible fruits of genus Musa. Musa is one of two or three genera in the family Musaceae; it includes bananas and plantains. Around 70 species of Musa are known. Any green bananas or plantains can be used in the product described herein. For example the green bananas may be any of the species Musa acuminate and Musa balbisiana or the hybrid Musa x paradisiaca. Non-limiting examples include Chingan banana, Lacatan banana, Lady Finger banana (Sugar banana), Pisang jari buaya (Crocodile fingers banana), Señorita banana (Monkoy, Arnibal banana, Cuarenta dias, Cariñosa, Pisang Empat Puluh Hari, Pisang Lampung), Sinwobogi banana, Dwarf Cavendish, Giant Cavendish (‘Williams’), Grand Nain (‘Chiquita’), Robusta, Dwarf Red banana, Gros Michel banana, East African Highland bananas, Golden Beauty banana, Atan banana, Goldfinger banana, Pink French banana, Tiger banana, Pome banana, and Latundan banana (Silk banana, Apple banana).

As used herein, the term “non-flesh banana plant material” includes green banana and plantain fruit material including skins, stems and/or flowers (i.e. banana flower ends) but excluding the flesh of the fruit and it also includes banana plant flowers (i.e. bells). Banana plant flowers are part of the banana plant and are called various names in different regions, including the male banana flower, the banana bell, the bunch bell, and banana blossom.

In green bananas and plantains, carbohydrate is present largely in the form of starch, including starch resistant to digestion (“resistant starch”) which is classified as dietary fibre. For example, starch makes up 70-80% of the dry weight of green bananas. As bananas ripen from green to yellow, enzymes within the banana convert the starch into simple sugars (sucrose, glucose and fructose) and, in doing so, the dietary fibre content decreases. Green bananas and plantains are also a good source of pectin which breaks down when a banana becomes overripe, which causes the fruit to become softer.

Commercially, it is easier to produce banana products from the pulp of yellow or ripe bananas. For example, banana powder, flakes and similar products are typically produced from ripened yellow bananas after peeling, dehydrating, grinding, and packaging. Such banana powders or flakes are typically used as nutritional ingredients in food, snack and beverage production.

Green bananas and plantains are difficult to process due to the hard texture of both the peel and the pulp. For example, green bananas and plantains are too firm to be fed into standard commercial automatic banana peelers and, therefore, they must be peeled by other methods, such as by hand. Moreover, even after peeling, the hard pulp (i.e., flesh) is difficult and slow to process. As a result, green bananas and plantains are time consuming and thus expensive to process. Whole green bananas and plantains may be softened using thermal processes to allow for greater ease of processing, such as peeling and pureeing. However, this step requires additional time and energy inputs.

Published U.S. Pat. Application No. 20130156893A1 (Han) describes a banana puree or powder that can be added to food products for human consumption. The banana puree or powder is formed from unpeeled green bananas that have been subjected to a heat treatment at a temperature and for a time sufficient to gelatinize starch present in the bananas. This process requires additional time and energy inputs for the heat treatment process and also results in a change in the starch content of the green bananas.

The present disclosure arises from research aimed at providing products having desirable appearance and/or health properties from whole green bananas and plantains and/or non-flesh banana plant material wherein the products have a similar or improved composition and/or nutrient profile to the starting green bananas or plantains. As such, the product may enjoy the benefit of being a natural product.

Product formed from dehydrated flesh of green bananas or plantains or dehydrated non-flesh banana plant material may be in the form a powder, flakes or crumble and may be used as a component of a pellet or tablet.

The product may be a feed product for human or animal consumption. For example, the feed product may be useful for a variety of mammals, including non-human mammals such as companion animals (e.g., dogs, cats, equine, birds, poultry, fish, rabbits, guinea pigs, reptiles, snakes, etc.), farm animals (e.g., alpacas, goats, sheep, swine, bovine, fowl, poultry, fish, etc.), wild and zoo animals (e.g., wolves, bears, deer, rodents, etc.), non-human primates (e.g., monkeys, chimpanzees, etc.), laboratory animals (e.g., mice, rats, etc.) and insects (e.g., bees). In certain embodiments, for example, the animal is a monogastric mammal (i.e., a mammal having a single stomach), such as, for example, a non-human primate, dog, cat, rabbit, horse, or swine. In certain specific embodiments, the animal is a horse.

An animal feed product as described herein may be a feed additive or supplement that is mixed with other feed materials to provide a complete feed for an animal. In these embodiments, the feed product may be mixed with other feed components, such as a protein component, an energy component, a carbohydrate source, a nutrient component, a functional food component, and/or a feed component. Each component may be present in an effective proportion such that, when administered to a mammal in need thereof in an effective amount.

In some embodiments a complete animal feed comprises a feed component comprising ingredients selected from the group consisting of alfalfa, corn meal, oats, and combinations of these. In some embodiments the complete animal feed further comprises a vitamin selected from the group consisting of vitamin A, vitamin B-1, vitamin B-2, vitamin B-3, vitamin B-6, vitamin B-12, vitamin C, vitamin D-3, vitamin E, vitamin K, biotin, choline, folic acid, and combinations of these. In some embodiments the complete feed comprises a nutrient component comprising at least one mineral selected from the group consisting of calcium, magnesium, potassium, boron, molybdenum, vanadium and combinations of these. Optionally, the nutrient component comprises at least one trace mineral selected from the group consisting of iron, copper, zinc, manganese, chromium, iodine, selenium, and combinations thereof. Optionally, the nutrient component comprises at least one antioxidant selected from the group consisting of CoQ10, pantothenic acid, DMG, grape seed extract, bioflavinoid, inositol, PABA, citrus bioflavonoid, pyctogen, and combinations of these. Optionally, the complete feed comprises a nutrient component comprising at least one amino acid selected from the group consisting of alanine, arginine, aspartic acid, cystine, glutamic acid, proline, glycine, histidine, hydroxyproline, isoleucine, leucine, lysine, methionine, phenylalanine, serine, threonine, tryptophan, tyrosine, valine, and combinations thereof. Optionally the complete feed comprises a protein component comprising the following constituents: whey powder, and lactase. The protein component may comprise at least one monosaccharide selected from the group consisting of glucose, galactose, fructose, and combinations of these.

The amount of feed product present in a complete animal feed may be from about 1% to about 90% (by weight), such as about 5% to about 20% (by weight).

The animal feed product can be administered at a dosage of 100 grams per average horse (being 14.5 hh or approximately 500 kg) or 20 grams per animal per day. This can be adjusted up or down depending on requirements of individual animals.

The product may be formulated for human consumption or use and may, for example, be used as, or a component of, a food additive, a dietary supplement, a food product, a pharmaceutical product, a nutraceutical product or a cosmetic product.

In certain embodiments, the product is a dietary supplement for human consumption. In these embodiments, the product may be in the form of a tablet, capsule, powder, solution, emulsion, etc. The product is formulated for oral consumption and may contain one or more pharmaceutically acceptable carriers, diluents or excipients, as is known in the art. Various excipients suitable for use are known in the art and can be used in the product. In particular, sweeteners, surfactants, buffers, preservatives, solubilisers, emulsifiers, bacteriostatic agents, colorants, and flavours can be used. The amounts of each excipient can readily be determined or ascertained by the person skilled in the art. Examples of suitable sweeteners include sucrose, dextrose, high fructose corn syrup, maltose, sorbitol, xylitol, mannitol, maltitol, sucralose, aspartame, saccharin, acesulfam K, and the like. Examples of suitable preservatives include esters of p-hydroxybenzoic acid, such as sodium methyl hydroxybenzoate and sodium propyl hydroxybenzoate.

The product formulated for human consumption can be administered at a dosage of 20 grams per human body weight per day. This can be adjusted up or down depending on requirements of individual.

The product in the form of a powder may be used in a nutraceutical composition or as a functional food. The nutraceutical composition can be a food product, foodstuff, functional food, or a supplement composition for a food product or a foodstuff. The food product may be a prepared and packaged food (e.g., mayonnaise, salad dressing, bread, or cheese food) or an animal feed (e.g., extruded and pelleted animal feed, coarse mixed feed or pet food composition). Functional foods are defined as foods being consumed as part of a usual diet but are demonstrated to have physiological benefits and/or reduce the risk of chronic disease beyond basic nutritional functions.

Nutraceutical food products or functional foods are for example beverages such as non-alcoholic and alcoholic drinks as well as liquid preparations to be added to drinking water and liquid food. Non-alcoholic drinks are for instance soft drinks; sport drinks; fruit juices, such as orange juice, apple juice and grapefruit juice; lemonades; teas; milk and other dairy drinks such as yogurt drinks, and diet drinks. Nutraceutical food products or functional foods can also be solid or semi-solid foods. These forms can include, but are not limited to, baked goods such as cakes and cookies; puddings; dairy products; confections; snack foods (e.g., chips); or frozen confections or novelties (e.g., ice cream, milk shakes); prepared frozen meals; candy; liquid food such as soups; spreads; sauces; salad dressings; prepared meat products; cheese; yogurt and any other fat or oil containing foods; and food ingredients (e.g., wheat flour).

Other ingredients can be added to nutraceutical food products or functional foods, for example, fillers, emulsifiers, preservatives, etc. for the processing or manufacture of the same. Additionally, flavors, coloring agents, spices, nuts and the like may be incorporated into the nutraceutical composition. Flavorings can be in the form of flavored extracts, volatile oils, chocolate flavorings, peanut butter flavoring, cookie crumbs, crisp rice, vanilla or any commercially available flavoring.

Emulsifiers can also be added for stability of the nutraceutical compositions. Examples of suitable emulsifiers include, but are not limited to, lecithin (e.g., from egg or soy), and/or mono- and diglycerides. Other emulsifiers are readily apparent to the skilled artisan and selection of suitable emulsifier(s) will depend, in part, upon the formulation and final product. Preservatives can also be added to the nutritional supplement to extend product shelf life. Preferably, preservatives such as potassium sorbate, sodium sorbate, potassium benzoate, sodium benzoate or calcium disodium EDTA are used.

In addition, the nutraceutical composition can contain natural or artificial sweeteners, e.g., saccharides, cyclamates, aspartamine, aspartame, acesulfame K, and/or sorbitol.

Moreover, a multi-vitamin and mineral supplement can be added to the nutraceutical composition to obtain an adequate amount of an essential nutrient. The multi-vitamin and mineral supplement can also be useful for disease prevention and protection against nutritional losses and deficiencies due to lifestyle patterns.

In certain embodiments, the product is used as a cosmetic. In these embodiments, the product may be applied for cosmetic purposes to the skin or a human or animal. Cosmetic compositions can cosmetic, hair, nail, or skin care products and examples include foundation, mascara, concealer, eyeliner, eyebrow, eye shadow, blusher, lipstick, lip balm, face powder, solid emulsion compact, etc. The product may be applied as is or it may be a component of a cosmetic composition. The cosmetic composition may comprise one or more other cosmetic ingredients, as is known in the art. For example, the cosmetic composition may contain the dehydrated green banana or plantain product in the form a powder and a physiologically acceptable medium. As used herein, the term “physiologically acceptable medium” means a non-toxic medium that can be applied to the human skin, lips or skin. The cosmetic composition may comprise any one or more of a colorant, a carrier, a desquamous active substance, an anti-acne active substance, an antiperspirant active substance, an anti-wrinkle agent/anti-atrophy agent, an antioxidant/radical scavenger, a chelating agent, a flavonoid, an anti-inflammatory agent, an anti-cellulite agent, a local anaesthetic, a sunburn active substance, a whitening agent, a skin sedation substance, a skin healing active substance, an antibacterial active substance, an antifungal active substance, a sunscreen active substance, particulate matter, a conditioning agent, a thickener, a structuring agent, a gelling agent, a powder ingredient, a substance that improves friction resistance or adhesion resistance, an emulsifier, and/or a co-solubiliser. Examples of suitable agents are disclosed in Japanese Patent No. JP4054835B2.

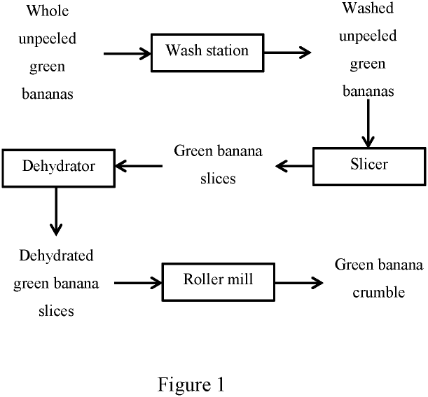

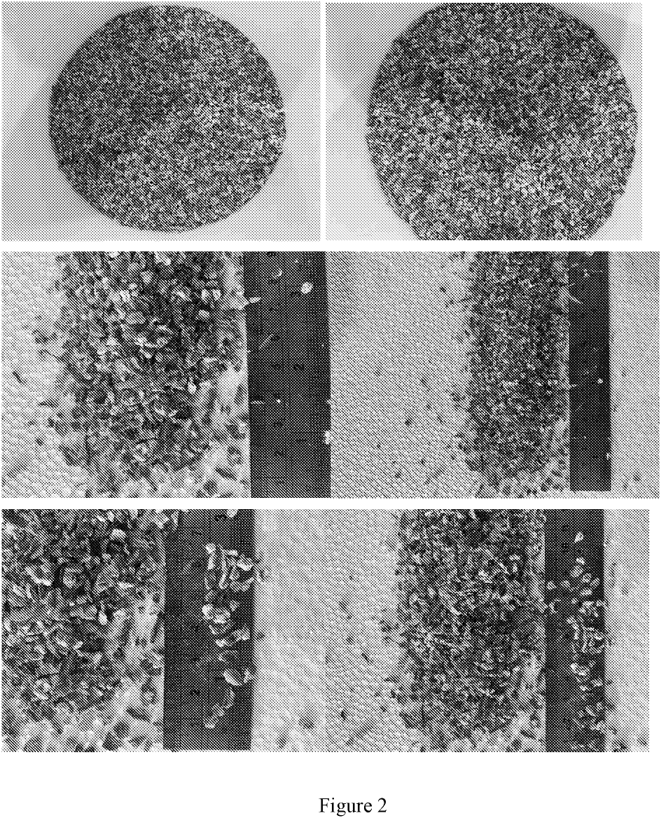

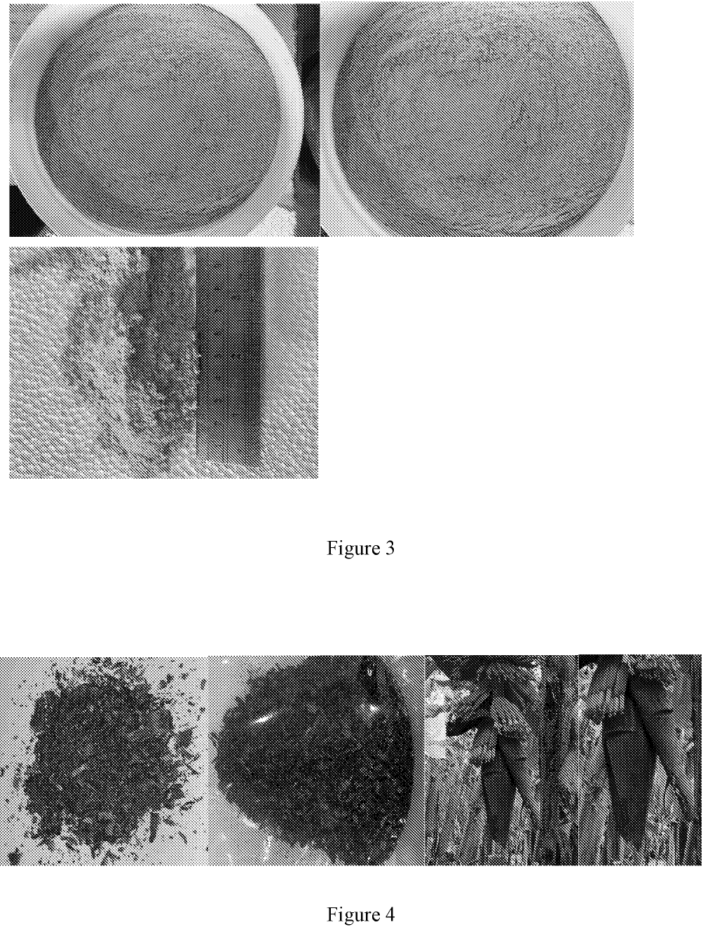

The feed product comprising dehydrated flesh of green bananas or plantains and/or non-flesh banana plant material can be formed using any suitable process. One example of a suitable process comprises a step of slicing green bananas or plantains to form green banana or plantain slices comprising banana or plantain flesh and skin. The green banana or plantain slices comprising flesh and skin can then either be dehydrated to form dried green banana or plantain slices to form the product in the form of slices or dehydrated and then comminuted to form the product comprising dehydrated flesh and skin of green bananas or plantains. An embodiment a suitable process is shown in FIG. 1 which shows a process comprising:
washing whole unpeeled green bananas or plantains comprising pulp, peel, stem and flower at a wash station to provide washed unpeeled green bananas or plantains;
slicing the washed unpeeled green bananas or plantains using a slicer to provide green banana or plantain slices comprising flesh and skin;
dehydrating the green banana or plantain slices using a dehydrator to provide dehydrated green banana or plantain slices;
optionally, comminuting the dehydrated green banana or plantain slices using a roller mill to produce green banana or plantain crumble.

In the process, the whole green banana or plantain comprising flesh, skin, stem and flower are used. This reduces processing time and costs as the stem, flower or skin do not need to be removed from the green banana or plantain. Furthermore, the skin, stem and flower form part of the product and this then provides a different composition or nutrient profile than would otherwise be obtained if only the flesh was used (as is the case with the production of green banana flour). As an alternative, the skin, stem and flower (i.e. non-flesh plant material) can be used as a stand-alone product or separately mixed with dehydrated flesh of green bananas and/or plantains.

Alternatively, or in addition, the process may use banana plant flowers (i.e. male banana flowers, banana bells, bunch bells or banana blossoms). Testing to date by the applicant indicates that banana plant flowers contain approximately three times the total antioxidants of a similar product formed from flesh, skin and stem material from green bananas or plantains.

In a first step of one suitable process, whole green bananas or plantains and/or non-flesh banana plant material are washed to substantially remove pathogens or other contaminants from the surfaces. The bananas or non-flesh banana plant material can be washed with any suitable solution or disinfectant. Suitable solutions include water. Suitable disinfectants include chlorine solution. A suitable chlorine solution has from about 50 to about 100 ppm chlorine. For example, the whole green bananas or plantains or non-flesh banana plant material may be contacted with a chlorine solution for a period of from about 3 minutes to about 15 minutes. After washing, the whole green bananas or plantains or non-flesh banana plant material are preferably substantially free of pathogens.

Following washing, the washed whole green bananas or plantains are sliced in a slicer. The slices may be any suitable thickness, such as between about 1 mm and about 20 mm. The slicer may be any suitable commercial slicer.

As used herein, the term “about” when used in reference to a value means the actual value is within ±30%, ±20%, ±10% or ±5% of the stated value.

After slicing, the green banana or plantain slices (with flesh and skin) are dehydrated. The slices can be dehydrated using any suitable method including (but not limited to) exposing them to a heat source. In certain embodiments, the green banana or plantain slices are dehydrated under conditions to achieve water activity of no greater than about 0.6. The water activity can be determined using a suitable moisture meter. Non-flesh banana plant material can be dehydrated in a similar manner.

In certain embodiments, the green banana or plantain slices or non-flesh banana plant material are dehydrated by exposing them to a heat source having a temperature of from about 50° C. to about 90° C. for a time period of from about 10 minutes to 180 minutes. In certain specific embodiments, the green banana or plantain slices or non-flesh banana plant material are exposed to a heat source having a temperature of about 80° C. for a time period of about 180 minutes.

Following dehydration, the dehydrated green banana or plantain slices or non-flesh banana plant material can be used as is as a food product. Alternatively, the dehydrated green banana or plantain slices or non-flesh or non-flesh banana plant material plant material can be comminuted to form a powder, flakes, crumble, etc. The dehydrated green banana or plantain slices or non-flesh or non-flesh banana plant material plant material can be comminuted using any suitable comminuting technique or apparatus, such as a jaw, cone or gyratory crusher, a hammer, ball, pin or rod mill, corrugated rollers, a grinder, and other shearing techniques.

As used herein the term “crumble” is to be taken as having the ordinary meaning in the art. For example, the typical particle size of a majority of a crumble is from about 0.2 cm to about 5 cm.

The product in the form of a powder, flakes, crumble may be used as a human or animal feed product. The feed product comprising dehydrated green banana or plantain flesh and non-flesh banana plant material or the dehydrated banana plant material may have a range of health and/or nutritional benefits in an animal or human. For example, the resistant starch and pectin in green bananas and plantains can provide a number of health benefits, including improved blood sugar control and better digestive health.

The feed product may have a resistant starch content of at least 30% (by weight), such as 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79% or 80% (by weight). In certain embodiments, the feed product has a resistant starch content of at least 39% (by weight). In certain specific embodiments, the feed product has a resistant starch content of at least 50% (by weight). In certain specific embodiments, the feed product has a resistant starch content of at least 60% (by weight).

Green bananas and plantains or non-flesh banana plant material are also a rich source of pharmacologically active substances that deliver substantial health benefits to animals and humans consuming them. Some of the active chemical compounds include:
Vitamins - A, C, E, B1, B2, B6, Niacin
Polyphenols - Flavonoids, Phenolic acids (Gallic, Catechin, Anthocyanins), Tannins, Stilbenes, Coumarins
Steroids, Triterpines, Amines (Dopamine, Norepinephrin, Seratonin)
Carotenoids - Lycopene, β-carotene

The health benefits that derive from consuming the food product comprising dehydrated green banana or plantain flesh and skin or non-flesh banana plant material are broad and may include:
Gut health: The resistant starch and insoluble fibre act as prebiotics to nourish beneficial microflora in the gut (particularly the hindgut) to stabilize the microbiome and create a state of eubiosis or harmony in the gut. This stability promotes immune competence allowing the animal to counter bacterial, fungal, viral or parasitic challenges. Gut stability also improves digestion, feed utilization and temperament and green bananas has been shown to have anti-ulcerative properties.
General wellbeing: Active compounds like dopamine, norepinephrine and serotonin all act to calm an animal and promote a sense of wellbeing, making the animal relaxed and easier to manage.
Antioxidant capacity: The burning of fuels at the cellular level (sugars and fats) and the normal functioning of the immune system create a degree of oxidative stress due to the formation of reactive oxygen species. These free radicals can damage tissue unless neutralized by the antioxidant tools at the animal’s disposal. Green banana is recognised as an antioxidant rich feed with a wide spectrum of antioxidant compounds (phenolics, carotenoids, ascorbic acid or Vitamin C, tocopherols or Vitamin E, dopamine, flavonoids, and norepinephrine) which are primarily located in the peel.

Other potential benefits that derive from consuming the food product comprising dehydrated green banana or plantain flesh and skin include:
Hypoglycemic (reduces cholesterol and improves insulin sensitivity)
Wound healing (as a topical application)
Anti-lithiatic (prevents kidney stones)

Thus, also disclosed herein is a method for providing a health benefit to a human or animal, the method comprising administering to a human or animal a physiologically effective amount of a dehydrated green banana or plantain or non-flesh banana plant material product as described herein. The health benefit may be one or more of improved gut health, improved general wellbeing, antioxidant effects, hypoglycaemic effect, reduced cholesterol, improved insulin sensitivity, improved wound healing, and anti-lithiatic effect.

In certain embodiments, the food product is an equine feed product. The present applicant has found that the aforementioned properties combine to improve the performance of equine athletes via improved appetite (as a result of gut health), improved coat through better nutrition and a calm tractable nature.

### Example

A human or animal feed product comprising dehydrated green banana flesh and skin was produced as follows. Whole green bananas comprising flesh, peel, stem and flower were washed in a 50-100 PPM aqueous chlorine solution for a period of 3-15 minutes. The washed greed bananas were then moved from the aqueous chlorine solution and transferred to a slicer where they were sliced across the banana into 1-20 mm slices. The slices comprised green banana flesh and skin. The slices were then transferred to a drying oven maintained at 80 ⊏C. The slices were kept in the oven for at least 40 minutes to form dehydrated slices. The dehydrated slices where then transferred to a roller mill where they were milled to produce a crumble having an average particle size of 0.001 to 20 mm.

The product had typical analyses shown in Tables 1 and 2.

TABLE 1

Typical analysis

| | | | |
|---|---|---|---|
| Moisture | | 5.0% | |
| Protein | | 3.9% | |
| Fat | | 1.6% | |
| Fiber | Crude | 2.2% | |
| | NDF | 7.1% | |
| | ADF | 5.7% | |
| Carbohydrates | Total Starch | 66.5% | |
| | Resistant Starch | 58.7% | |
| | Free Sugars | 2.8% | |
| Ash | | 4.8% | |
| Macrominerals | mg/kg | Ca | 1200 |
| | | P | 870 |
| | | K | 22800 |
| | | Na | 41 |
| | | S | 357 |
| | | Mg | 1080 |
| Trace Minerals | mg/kg | Cu | 9.6 |
| | | Fe | 3.5 |
| | | Zn | 13.4 |
| | | Mn | 16.5 |

TABLE 2

Typical analysis

| Sample Description | Method | Unit | B821700-1 GREEN BANANA FEED |
|---|---|---|---|
| Test | | | |
| Protein | CF003 1 | [symbol] | 3.9 |
| Fat | CF004 1 | [symbol] | 1.6 |
| Ash | CF007 | [symbol] | 5.1 |
| Crude Fibre | CF038 1 | [symbol] | 2.2 |
| Dry Matter# | CF006 1 | [symbol] | 94.9 |
| Nitrogen Free Extract DWB# | CF037 1 | [symbol] | 86.5 |
| Metabolisable Energy DWB#•{Cattle } | CF037 4 | MUkg | 13.3 |
| Total sugar {Sucrose } | CF047 | [symbol] | 4.2 |
| Moisture (air ) | CF0051 | [symbol] | 5.1 |
| Starch• | CF031 1 | [symbol] | 60.0 |
| Metabolsable Energy # (Poultry ) | CF037 4C | MUkg | 12.6 |
| Nitrogen Free Extract #• | CF037 1 | [symbol] | 82.1 |
| Metabolisable Energy # (Pet) | CF037 4D | MUkg | 13.2 |
| Digestible Energy DWB# | CF037 5H | MUkg | 14.3 |
| Digestible Energy Pig DWB# | CF037 5P | MUkg | 15 |
| Arsenic (AS) | ESM02 | mgkg | <0.025 |
| Cadmium (Cd) | ESM02 | mgkg | <0.01 |
| Cobalt (Co) | ESM02 | mgkg | 0.02 |
| Chromium (Cr) | ESM02 | mgkg | 0.13 |
| Mercury (Hg) | ESM02 | mgkg | <0.01 |
| Lead (Pb) | ESM02 | mgkg | 0.011 |
| Antimony (Sb) | ESM02 | mgkg | <0.01 |
| Tin(Sn) | ESM02 | mgkg | 0.56 |
| Aluminum (Al)i | ESI02 | mgkg | 18.0 |
| Calcium (Ca) | ESI02 | mgkg | 1,200 |
| Chromium (Cr) | ESI02 | mgkg | <0.5 |
| Copper (Cu) | ESI02 | mgkg | 9.6 |
| Iron (Fe) | ESI02 | mgkg | 3.5 |
| Lead (Pb) | ESI02 | mgkg | <0.5 |
| Magnesium (Mg) | ESI02 | mgkg | 1,060 |
| Manganese (Mn) | ESI02 | mgkg | 16.5 |
| Morybdenun (Mo) | ESI02 | mgkg | <0.2 |
| Nickel (Ni) | ESI02 | mgkg | <0.2 |
| Phosphorus (P) | ESI02 | mgkg | 870 |
| Potassium (K) | ESI02 | mgkg | 22,800 |
| Selenium(Se) | ESI02 | mgkg | <0.5 |
| Sodium(Na) | ESI02 | mgkg | 41 |
| Sulfur(S) | ESI02 | mgkg | 357 |
| Zinc(Zn) | ESI02 | mgkg | 13.4 |

[symbol]

indicates text missing or illegible when filed

The product is a pure, natural product free of any additives. The high starch predominantly as resistant starch in the product provides for orderly energy release and prebiotic promotion of gut health. The insoluble fibre assists with gut integrity. The phyto-active molecules provide antioxidant protection and a calmer temperament. The product is high in potassium for electrolyte balance in equine athletes.

The composition of the feed product described herein and as shown in Tables 1 and 2 is different to the composition of a commercially available dried green banana powder that is produced from green banana flesh under is available from Natural Evolution. The composition of this commercial product is shown in Table 3.

TABLE 3

Composition of Natural Evolution Green Banana Resistant Starch product (from https://www.naturalevolutionfoods.com.au/nutritional-information/ accessed 29/01/2020).

| | |
|---|---|
| | Quantity per 100 g |
| Energy | 1412kj |
| Protein | 3.2 g |
| Fat-Total | <1 g |
| -saturated | <1 g |
| -monounsaturated | <1 g |
| -polyunsaturated | <1 g |
| -trans | <1 g |
| Fibre - total dietary | 12 g |
| Carbohydrates available | 37 g |
| - sugars | <1 g |
| Sodium | <1 g |
| Potassium (K) | 1230 mg |
| Zinc (Zn) | 6.2 mg |
| Magnesium (Mg) | 121 mg |
| Vitamin E | 1.8 IU |
| Manganese | 3.7 mg |
| Resistant Starch | 38 g |
| Inulin (including total dietary fibre) | 4 g |
| HTP 5 (Hydroxytryptophan) serotonin | 13.2 mg |
| Vitamin B3 | 530ug |
| Vitamin B6 | 260ug |

The composition of the feed product described herein and as shown in Tables 1 and 2 was assayed and has the amino acid composition shown in Table 4.

TABLE 4

Typical amino acid analysis

| Amino acid | mg g-1 | Mole% |
|---|---|---|
| Aspartic Acid | 1.91 | 7.15% |
| Serine | 1.79 | 8.49% |
| Glutamic acid | 2.59 | 8.76% |
| Histidine | 3.13 | 10.04% |
| Glycine | 0.21 | 1.39% |
| Arginine | 2.56 | 7.31% |
| Threonine | 0.31 | 1.30% |
| Alanine | 1.21 | 6.77% |
| Proline | 1.66 | 7.16% |
| Tyrosine | 1.37 | 3.77% |
| Valine | 1.04 | 4.41% |
| Methionine | Not detected | Not detected |
| Lysine | 1.15 | 3.92% |
| Isoleucine | 2.74 | 10.41% |
| Leucine | 2.79 | 10.59% |
| Phenylalanine | 2.83 | 8.53% |
| Total | 27.29 | 100.00% |

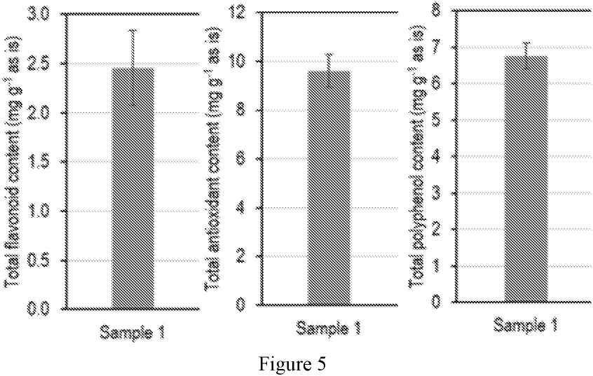

The total flavanoid content, total antioxidant content and total polyphenol content of the product is shown in FIG. 5.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

Please note that the following claims are provisional claims only, and are provided as examples of possible claims and are not intended to limit the scope of what may be claimed in any future patent applications based on the present application. Integers may be added to or omitted from the example claims at a later date so as to further define or re-define the invention.

1. A product comprising dehydrated flesh of green bananas and/or plantains and/or dehydrated non-flesh banana plant material.

2. The product according to claim 1, wherein the non-flesh banana plant material comprises skins or stems or flowers.

3-4. (canceled)

5. The product according to claim 2, wherein the product has a resistant starch content of at least 39% (by weight).

6. (canceled)

7. The product according to claim 2, wherein the product is in the form of a crumble or a powder.

8. (canceled)

9. The product according to claim 2, wherein the product is an animal or human feed product or a nutraceutical product or a component of a nutraceutical product.

10. (canceled)

11. A process for producing a product comprising dehydrated flesh and skin of green bananas or plantains, the process comprising:
slicing whole green bananas or plantains to form banana or plantain slices comprising flesh and skin;
dehydrating said banana or plantain slices to form dried green banana or plantain slices to form the product in the form of slices; or
dehydrating said banana or plantain slices to form dehydrated green banana slices and comminuting said dehydrated banana or plantain slices to form the product comprising dehydrated flesh and skin of green bananas or plantains.

12. The process of claim 11, wherein the whole green bananas or plantains comprise flesh, peel, stem and flower material.

13. (canceled)

14. The process of claim 11, wherein the slices have a thickness of between about 1 mm and about 20 mm.

15. The process of claim 11, comprising dehydrating the green banana or plantain slices under conditions to achieve water activity of no greater than 0.6.

16. (canceled)

17. The process of claim 11, comprising dehydrating the green banana or plantain slices by exposing them to a heat source having a temperature of from about 50° C. to about 90° C. for a time period of from about 10 minutes to 180 minutes.

18-24. (canceled)

25. A method for providing a health benefit to a human or animal, the method comprising administering to a human or animal a physiologically effective amount of the product according to claim 2.

26. The method of claim 25, wherein the health benefit is selected from one or more of the group consisting of improved gut health, improved general wellbeing, antioxidant effects, hypoglycaemic effect, reduced cholesterol, improved insulin sensitivity, improved wound healing, and anti-lithiatic effect.

27. A product comprising dehydrated non-flesh banana plant material comprising skins, stems or flowers.

28-30. (canceled)

31. The human or animal feed product according to claim 27, wherein the feed product is in the form of a crumble or a powder.

32. (canceled)

33. The product according to claim 27, wherein the product is an animal or human feed product or a nutraceutical product or a component of a nutraceutical product.

34. (canceled)

35. A process for producing a product comprising dehydrated non-flesh banana plant material, the process comprising:
obtaining whole or part non-flesh plant material from green bananas or plantains;
dehydrating said whole or part non-flesh plant material to form dehydrated non-flesh banana plant material; and
optionally comminuting said dehydrated non-flesh banana plant material to form the product comprising dehydrated non-flesh banana plant material.

36. The method according to claim 35, wherein the non-flesh banana plant material comprises skins or stems or flowers.

37-38. (canceled)

39. The method according to claim 35, further comprising mixing said dehydrated non-flesh banana plant material and/or comminuted dehydrated non-flesh banana plant material with dehydrated flesh of green bananas or plantains to form a product comprising dehydrated flesh of green bananas or plantains and non-flesh banana plant material.
